(19) United States
(12) Patent Application Publication
(10) Pub. No.: US 2024/0002625 A1
(43) Pub. Date: Jan. 4, 2024

(54) RUBBER MODIFIED BITUMINOUS BINDERS

(71) Applicant: CSIR, Brummeria (ZA)

(72) Inventor: George Akim Jasper MTURI, Pretoria (ZA)

(73) Assignee: CSIR, Brummeria (ZA)

(21) Appl. No.: 18/253,635

(22) PCT Filed: Nov. 18, 2021
(86) PCT No.: PCT/IB2021/060691

§ 371 Date: May 19, 2023

(30) Foreign Application Priority Data
Nov. 19, 2020 (ZA) 2020/07201

(51) Int. Cl. C08J 11/06; C08L 95/00

(52) U.S. Cl. CPC C08J 11/06; C08L 95/00; C08L 2555/34; C08L 2555/40; C08J 2495/00

(57) ABSTRACT

A method of re-stiffening an over-digested rubber modified bituminous binder includes admixing a reactive, stiffness inducing organic additive with the over-digested rubber modified bituminous binder to produce a re-stiffened rubber modified bituminous binder with an increased softening point. The admixing takes place at an elevated temperature of at least 185° C. A rubber modified bituminous binder suitable for both asphalt and seal surfacing applications that includes a digested rubber bituminous admixture with a softening point of at least 55° C. and a dynamic viscosity at 190° C. of less than 2000 mPa·s. A method of sealing or paving a surface includes applying a layer which includes a rubber modified bituminous binder to the surface, the rubber modified bituminous binder being in the form of a digested rubber bitumen admixture with a softening point of at least 55° C. and a dynamic viscosity at 190° C. of less than 2000 mPa·s.

### CROSS-REFERENCE TO RELATED APPLICATIONS

This application is a national stage application filed under 35 U.S.C. § 371 of PCT Application No. PCT/IB2021/060691, filed Nov. 18, 2021, which claims priority to South Africa Patent Application No. 2020/07201, filed Nov. 19, 2020, the entire contents of each of which is hereby incorporated by reference.

### BACKGROUND OF THE DISCLOSURE

### 1. Field of the Disclosure

This Disclosure relates to rubber modified bituminous binders. In particular, the disclosure relates to a method of re-stiffening an over-digested rubber modified bituminous binder, to a rubber modified bituminous binder, and to a method of sealing or asphalt paving a surface.

### 2. Description of Related Art

In for example South Africa, crumb rubber modified bituminous binder has historically been manufactured in a wet process to a criteria as set out in a document known as Technical Guideline (TG 1), The Use of Modified Bituminous Binders in Road Construction (Third Edition), SABITA, Howard Place, South Africa, 2015, ISBN 978-1-874968-67-2 (hereinafter referred to as TG1, 2015) through blending penetration grade bitumen (72-82% by mass), rubber crumbs (18-24% by mass) and extender oil or high boiling point fluxing agents (0-4% by mass) at elevated temperatures of typically between 190-210° C. The blending is done by a high-speed stirring device for 1 to 4 hours until the bitumen is considered modified.

The typical base bitumen or base bituminous binder conventionally used in South Africa was the 70/100 penetration grade bitumen conforming to the requirements of South African National Standard 4001-BT1 [SANS 4001-BT1]. 2014. Penetration Grade Bitumens (Edition 1.2). South Africa: Standards South Africa (hereinafter referred to as SANS 4001-BT1, 2014). Historically, the extender oil was produced as per the requirements of the Committee of Land Transport Officials ([COLTO](1998), Standard Specifications for Road and Bridge Works for State Road Authorities (1998 Edition), South Africa: South African Institution of Civil Engineering) (hereinafter referred to as COLTO, 1998). Rubber crumbs of the grading requirements stated in TG1, 2015 are recommended. The rubber crumb particles essentially pass a 1.00 mm sieve (1.18 mm was the requirement in a previous guideline document i.e., TG1, 2007) and the majority is retained on a 0.6 mm sieve.

In the wet process of using crumb rubber to modify asphalt mixes, the crumb rubber is thus digested in bitumen using a combination of high temperatures, agitation and controlled digestion times. This produces rubber modified bitumen with enhanced elastic properties that can contain up to 25% rubber digested in bitumen. The limitations of this production route have historically been the high handling temperatures, the heterogeneous nature of rubber modified bituminous binder material and the limited window period of application for these binder materials to have optimum performance.

In South Africa, rubber modified bituminous blends used to be tested according to the methods and requirements in TG 1, 2015. TG 1, 2015 has a minimum viscosity requirement of 2000 mPa·s (or 20 dPa.S) for rubber modified bituminous binder grades used in sealing (grade 5-R1) and asphalt mix (grade A-R1) applications. Traditionally, when rubber modified bituminous blends are over-digested and their viscosity fall below the minimum specification, their further usage is restricted to blending them into new batches of rubber modified bituminous binder up to a maximum proportion of 20% by mass of over-digested binder. Although rubber modified bituminous binders have been used successfully in South Africa for the past 25 years, a constant challenge for asphalt/seal manufacturers is that the rate of disposal of the over-digested binder is often less than the rate of accumulation of the over-digested binder, aggravated at times of inclement weather.

### SUMMARY OF THE DISCLOSURE

According to one aspect of the disclosure, there is provided a method of re-stiffening an over-digested rubber modified bituminous binder, the method including admixing a reactive, stiffness inducing organic additive with the over-digested rubber modified bituminous binder to produce a re-stiffened rubber modified bituminous binder with an increased softening point, wherein the admixing takes place at an elevated temperature of at least 185° C.

Typically, the re-stiffened rubber modified bituminous binder also exhibits an improved Jₙᵣ. An improved Jₙᵣ is a Jₙᵣ value, in kPa⁻¹, for the re-stiffened rubber modified bituminous binder, which is lower than said Jₙᵣ value, in kPa⁻¹, for the over-digested rubber modified bituminous binder, over a stress range of at least 100-10000 Pa, using a multiple stress creep and recovery test.

The re-stiffened rubber modified bituminous binder typically also exhibits an improved storage stability. An improved storage stability is a storage stability value, in ° C., for the re-stiffened rubber modified bituminous binder, which is lower than said storage stability value, in ° C., for the over-digested rubber modified bituminous binder using a storage stability of polymer modified binders (TG1 MB-6) test.

The re-stiffened rubber modified bituminous binder typically also exhibits an improved stress resilience. An improved stress resilience is Jₙᵣ values, in kPa⁻¹, for the re-stiffened rubber modified bituminous binder, which display a lower change with increased stress than said Jₙᵣ values, in kPa⁻¹, for the over-digested rubber modified bituminous binder, over a stress range of at least 100-10000 Pa, using a multiple stress creep and recovery test.

In this specification, an over-digested rubber modified bituminous binder is a rubber modified bituminous binder with a viscosity at 190° C. of less than 2000 mPa·s and/or with a softening point of less than 55° C.

Preferably, the over-digested rubber modified bituminous binder is completely over-digested. A completely over-digested rubber modified bituminous binder is an over-digested rubber modified bituminous binder whose viscosity approaches that of a base bituminous binder of the rubber modified bituminous binder, once the viscosity has dropped below 2000 mPa·s, and/or a completely over-digested rubber modified bituminous binder is an over-digested rubber modified bituminous binder whose softening point approaches that of the base binder, once the softening point has dropped below 55° C.

If necessary, the method of the disclosure may include digesting the over-digested rubber modified bituminous binder for a period of time sufficient to ensure that the over-digested rubber modified bituminous binder is completely over-digested, prior to admixing the reactive, stiffness inducing organic additive with the over-digested rubber modified bituminous binder.

The rubber in the rubber modified bituminous binder may be crumb rubber. The crumb rubber may be as hereinbefore described, e.g. in accordance with TG 1, 2015.

The bitumen in the rubber modified bituminous binder may include a base bitumen as hereinbefore described and the rubber modified bituminous binder, prior to becoming over-digested, may be prepared in accordance with the guidelines set out in TG 1, 2015. The rubber modified bituminous binder may thus include an extender oil or high boiling point fluxing agents.

The reactive, stiffness inducing organic additive may be reactive in the sense that reactions between one or more components of the reactive, stiffness inducing organic additive react(s) with functional groups present in the over-digested rubber modified bituminous binder to produce a re-stiffened rubber modified bituminous binder with an altered composition and an increased softening point.

In one embodiment of the method of the disclosure, these reactions provide an increase (compared to over-digested rubber modified bituminous binder) in weight fraction of components of the re-stiffened rubber modified bituminous binder with a molar mass over at least part of a molar mass range between 2×10⁶ and 8×10⁶ g/mol, or between 2×10⁶ and 7×10⁶ g/mol, or between 3×10⁶ and 8×10⁶ g/mol or between 3λ10⁶ and 7×10⁶ g/mol, e.g. between 4×10⁶ and 6×10⁶ g/mol.

The reactive, stiffness inducing organic additive may be reactive in the sense that reactions between one or more components of the reactive, stiffness inducing organic additive react(s) with functional groups (e.g. carboxylic acid functional groups) present in the over-digested rubber modified bituminous binder to produce a re-stiffened rubber modified bituminous binder with an improved Jₙᵣ, and/or an improved storage stability and/or an improved stress resilience.

The reactive, stiffness inducing organic additive may be a reactive elastomeric organic additive.

The reactive, stiffness inducing organic additive may be a reactive elastomeric polymer composition.

The reactive, stiffness inducing organic additive may be a reactive elastomeric terpolymer composition. The terpolymer composition may include ethylene as a monomer. Instead, or in addition, the terpolymer may include an alkyl acrylate as a monomer. Instead, or in addition, the terpolymer may include glycidyl methacrylate as a monomer.

In one embodiment of the disclosure, the reactive elastomeric terpolymer is a terpolymer of ethylene, an alkyl acrylate and glycidyl methacrylate. An example of such a terpolymer is a reactive stiffness inducing terpolymer of ethylene/n-butyl acrylate/glycidyl methacrylate. The glycidyl methacrylate may be present in a concentration of about 9% by mass.

The admixing of the reactive, stiffness inducing organic additive with the over-digested rubber modified binder should be in the absence of poly-phosphoric acid. When admixed in the presence of poly-phosphoric acid, which is often used with products such as a terpolymer composition of ethylene/n-butyl acrylate/glycidyl methacrylate, the inventor surprisingly found that the poly-phosphoric acid had a negative effect on the desired properties of the re-stiffened rubber modified bituminous binder.

Preferably, the admixing takes place at an elevated temperature of between about 185° C. and about 210° C., more preferably between about 190° C. and about 200° C., most preferably between about 190° C. and about 195° C., e.g. at about 193° C.

The admixing may be for less than about 160 minutes, preferably less than about 145 minutes, more preferably less than about 130 minutes, e.g. about 120 minutes.

The admixing may be for at least about 100 minutes, preferably at least about 110 minutes, more preferably at least about 120 minutes.

The re-stiffened rubber modified bituminous binder may have an increased softening point to at least 56° C., preferably to at least 58° C., more preferably to at least 60° C., e.g. to at least 61° C.

The re-stiffened rubber modified bituminous binder may show a reduction in elasticity with an increase in the complex modulus (G*), as evidenced by reduced phase angles at high in-service temperatures. This can best be seen on a Black diagram plot of complex modulus versus phase angle, at various frequencies and in-service temperatures, using data from a dynamic shear rheometer.

With high in-service temperatures is meant a temperature at which the re-stiffened rubber modified bituminous binder would normally be used to resist deformation, e.g. when an asphalt road carries traffic in a hot summer season, i.e. at temperatures in the range of between about 20° C. and about 70° C.

The stiffness inducing organic additive and the over-digested rubber modified binder may be admixed in a mass ratio of between about 0.5:99.5 and about 2.0:98.0, preferably between about 0.5:99.5 and about 1.5:98.5, more preferably between about 0.8:99.2 and about 1.2:98.8, e.g. about 1.0:99.0.

The disclosure extends to a re-stiffened rubber modified bituminous binder when produced by the method of re-stiffening an over-digested rubber modified bituminous binder as herein before described.

The re-stiffened rubber modified bituminous binder may have a softening point of at least 56° C., preferably at least 58° C., more preferably at least 60° C., e.g. at least 61° C.

In one embodiment of the re-stiffened rubber modified bituminous binder produced by the method of re-stiffening an over-digested rubber modified bituminous binder, the re-stiffened rubber modified bituminous binder has an increased weight fraction (compared to over-digested rubber modified bituminous binder) of components of the re-stiffened rubber modified bituminous binder with a molar mass over at least part of a molar mass range between 2×10⁶ and 8×10⁶ g/mol, or between 2×10⁶ and 7×10⁶ g/mol, or between 3×10⁶ and 8×10⁶ g/mol or between 3λ10⁶ and 7×10⁶ g/mol, e.g. between 4×10⁶ and 6×10⁶ g/mol.

The re-stiffened rubber modified bituminous binder produced by the method of re-stiffening an over-digested rubber modified bituminous binder may have a dynamic viscosity at 190° C. of less than about 2000 mPa·s, or less than about 1500 mPa·s, or less than about 1200 mPa·s, or less than about 1000 mPa·s, or less than about 900 mPa·s, e.g. about 800 mPa·s. As will be appreciated, the dynamic viscosity of the re-stiffened rubber modified bituminous binder will depend on the formulation thereof, and on the reactive, stiffness inducing organic additive used.

Preferably, the re-stiffened rubber modified bituminous binder has a dynamic viscosity at 190° C. of at least 100 mPa·s.

According to another aspect of the disclosure, there is provided a rubber modified bituminous binder, the binder including a digested rubber bituminous admixture with a softening point of at least 55° C. and a dynamic viscosity at 190° C. of less than 2000 mPa·s.

Preferably, the rubber modified bituminous binder has a softening point of at least 56′C, more preferably at least 58′C, most preferably at least 60′C, e.g. at least 61° C. As will be appreciated, the softening point will depend on the formulation of the rubber modified bituminous binder.

The rubber modified bituminous binder may have a dynamic viscosity at 190′C of less than about 1500 mPa·s, or less than about 1200 mPa·s, or less than about 1000 mPa·s, or less than about 900 mPa·s, e.g. about 800 mPa·s. As will be appreciated, the dynamic viscosity will depend on the formulation of the rubber modified bituminous binder.

Preferably, the rubber modified bituminous binder has a dynamic viscosity at 190° C. of at least 100 mPa·s.

The rubber modified bituminous binder, or the re-stiffened rubber modified bituminous binder, may have a compression recovery at 5 minutes, according to the MB-11 test method as set out in TG 1, 2015, of more than 70%, or more than 80%. As will be appreciated, the compression recovery at 5 minutes will depend on the formulation of the rubber modified bituminous binder.

The rubber modified bituminous binder, or the re-stiffened rubber modified bituminous binder, may have a compression recovery after 1 hour, according to the MB-11 test method, of more than 70%, preferably more than 75%, more preferably more than 80%, e.g. 85.6%. As will be appreciated, the compression recovery after 1 hour will depend on the formulation of the rubber modified bituminous binder.

The rubber modified bituminous binder, or the re-stiffened rubber modified bituminous binder, may have a compression recovery after 24 hours, according to the MB-11 test method, of more than 40%, preferably more than 50%, more preferably more than 60, e.g. 69.9. As will be appreciated, the compression recovery after 24 hours will depend on the formulation of the rubber modified bituminous binder.

The rubber modified bituminous binder, or the re-stiffened rubber modified bituminous binder, may have a compression recovery after 4 days, according to the MB-11 test method, of more than 40, preferably more than 50%, more preferably more than 60%, e.g. 67.9%. As will be appreciated, the compression recovery after 4 days hours will depend on the formulation of the rubber modified bituminous binder.

The rubber modified bituminous binder, or the re-stiffened rubber modified bituminous binder, may have a resilience at 25° C., according to the MB-10 test method as set out in TG 1, 2015, of more than 13%, preferably more than 14%, more preferably more than 15%, e.g. 17.3%. As will be appreciated, the resilience at 25° C. will depend on the formulation of the rubber modified bituminous binder.

The rubber modified bituminous binder, or the re-stiffened rubber modified bituminous binder, may flow, according to the MB-12 test method as set out in TG 1, 2015, more than 10 mm, or more than 15 mm, preferably more than 20 mm, more preferably more than 25 mm, e.g. 28 mm. As will be appreciated, the flow will depend on the formulation of the rubber modified bituminous binder.

In one embodiment of the disclosure, the rubber modified bituminous binder, or the re-stiffened rubber modified bituminous binder, has a weight fraction of at least about 0.13, preferably at least about 0.15, more preferably at least about 0.18, most preferably at least about 0.2 of components with an average molar mass between 3.9×10⁶ g/mol and 4.1×10⁶ g/mol.

In one embodiment of the disclosure, the rubber modified bituminous binder, or the re-stiffened rubber modified bituminous binder, has a weight fraction of at least about 0.13, preferably at least about 0.15, more preferably at least about 0.18, most preferably at least about 0.2 of components with an average molar mass between 4.1×10⁶ g/mol and 4.2×10⁶ g/mol. As will be appreciated, said weight fraction will depend on the formulation of the rubber modified bituminous binder.

The rubber modified bituminous binder, or the re-stiffened rubber modified bituminous binder, may include reaction products from reactions between glycidyl methacrylate and functional groups of the over-digested bituminous binder (e.g. carboxylic acid groups).

The rubber modified bituminous binder may be produced by a method of re-stiffening an over-digested rubber modified bituminous binder as hereinbefore described.

The rubber modified bituminous binder may be produced from over-digested rubber modified bituminous binder. The over-digested rubber modified bituminous binder may be as herein before described.

The rubber in the rubber modified bituminous binder may be crumb rubber.

The rubber modified bituminous binder, or the re-stiffened rubber modified bituminous binder, may be for use as a surface seal in a method of sealing a surface.

The rubber modified bituminous binder, or the re-stiffened rubber modified bituminous binder, may be for use as a binder in an asphalt mix for asphalt paving a surface.

According to a further aspect of the disclosure, there is provided a method of sealing or asphalt paving a surface, the method including applying a layer which includes a rubber modified bituminous binder to the surface, the rubber modified bituminous binder being in the form of a digested rubber bitumen admixture with a softening point of at least 55° C. and a dynamic viscosity at 190° C. of less than 2000 mPa·s.

The layer typically includes aggregate particles, particularly when the method is an asphalt paving method. The rubber modified bituminous binder and the aggregate particles thus may a seal surfacing layer or a layer of an asphalt mix. The method of sealing or asphalt paving a surface may thus be a method of paving a surface with asphalt or an asphalt mix, sometimes referred to as asphalt concrete.

The asphalt mix may be a medium continuously graded mix and may have a maximum displacement (using a Universal Testing Machine test setup, i.e. a UTM-25 test setup for dynamic modulus testing, with gyratory compacted specimens size of 100 mm diameter and 150 mm high 25 cored from cylindrical medium continuous specimens of 150 mm in diameter by 170 mm high, a single applied stress (deviator stress) level of 276 kPa and 69 kPa confinement pressure at 40° C., with the deviator stress repeatedly pulsed in the vertical direction on the specimens using a haversine pulse load of 0.1 seconds and 0.9 seconds rest period until flow or 10,000 load cycles) equal to an identical asphalt SBS mix (in terms of mix design, grading, aggregate type and binder content) based on an A-E2 conforming SBS binder, preferably better than (e.g. at least 25% better), more preferably notably better than (e.g. at least 50% better), most preferably more than double, the performance, e.g. 1.6-2.6 mm as opposed to 7.3-7.6 mm, of the identical asphalt SBS mix.

The asphalt mix may be a medium continuously graded mix and may have a flow number (using a UTM-25 test setup for dynamic modulus testing, with gyratory compacted specimens size of 100 mm diameter and 150 mm high cored from cylindrical medium continuous specimens of 150 mm in diameter by 170 mm high, a single applied stress (deviator stress) level of 276 kPa and 69 kPa confinement pressure at 40′C, with the deviator stress repeatedly pulsed in the vertical direction on the specimens using a haversine pulse load of 0.1 seconds and 0.9 seconds rest period until flow or 10,000 load cycles) equal to an identical asphalt SBS mix (in terms of mix design, grading, aggregate type and binder content) based on an A-E2 conforming SBS binder, preferably better than (e.g. at least 25% better), more preferably notably better than (e.g. at least 50% better), most preferably more than double, the performance, e.g. 5700-8700 as opposed to 900-2000, of the identical asphalt SBS mix.

The asphalt mix may be a bitumen-rubber asphalt semi-open (BRASO) graded mix and may have a maximum displacement (using a UTM-25 test setup for dynamic modulus testing, with gyratory compacted specimens size of 100 mm diameter and 150 mm high cored from cylindrical medium continuous specimens of 150 mm in diameter by 170 mm high, a single applied stress (deviator stress) level of 276 kPa and 69 kPa confinement pressure at 40° C., with the deviator stress repeatedly pulsed in the vertical direction on the specimens using a haversine pulse load of 0.1 seconds and 0.9 seconds rest period until flow or 10,000 load cycles) equal to an identical asphalt mix (in terms of mix design, grading, aggregate type and binder content) based on an A-R1 conforming crumb rubber modified bituminous binder, preferably better than (e.g. at least 25% better), more preferably notably better than (e.g. at least 50% better), most preferably more than double, the performance, e.g. 0.7-1.1 mm as opposed to 3.5-7.5 mm, of the identical asphalt mix based on an A-R1 conforming crumb rubber modified bituminous binder.

The asphalt mix may be a bitumen-rubber asphalt semi-open (BRASO) graded mix and may have a flow number (using a UTM-25 test setup for dynamic modulus testing, with gyratory compacted specimens size of 100 mm diameter and 150 mm high cored from cylindrical medium continuous specimens of 150 mm in diameter by 170 mm high, a single applied stress (deviator stress) level of 276 kPa and 69 kPa confinement pressure at 40° C., with the deviator stress repeatedly pulsed in the vertical direction on the specimens using a haversine pulse load of 0.1 seconds and 0.9 seconds rest period until flow or 10,000 load cycles) equal to an identical asphalt mix (in terms of mix design, grading, aggregate type and binder content) based on an A-R1 conforming crumb rubber modified bituminous binder, preferably better than (e.g. at least 25% better), more preferably notably better than (e.g. at least 50% better), most preferably more than double, the performance, e.g. 7400-8800 as opposed to 1400-4200, of the identical asphalt mix based on an A-R1 conforming crumb rubber modified bituminous binder.

The rubber modified bituminous binder may be as hereinbefore described.

The aggregate particles may be conventional aggregate particles e.g. used in paving, such as road construction, and the ratio of rubber modified bituminous binder and aggregate particles in the layer may be entirely conventional.

### BRIEF DESCRIPTION OF THE DRAWINGS

The disclosure will now be described in more detail with reference to the accompanying drawings in which

FIG. 1-1 shows a graph of the size grading of crumb rubber particles used in studies conducted by the inventor;

FIG. 1-2 shows scanning electron microscope (SEM) photographs of the rubber crumbs, illustrating the surface texture/morphology of the rubber crumbs;

FIG. 2-1 shows a typical digestion viscosity curve of crumb rubber modified bituminous binder;

FIG. 2-2 shows digestion viscosity curves of crumb rubber modified bituminous binders or blends at different handling temperatures, as a function of time;

FIG. 2-3 shows a Black diagram of crumb rubber modified bituminous binder (CRM binder) with PAV-ageing before and after solvent-soluble recovery;

FIG. 2-4 shows digestion viscosity curves of two crumb rubber modified bituminous binders or blends at 190-200° C., as a function of time;

FIG. 2-5 shows digestion viscosity curves of two crumb rubber modified bituminous binders or blends based on base binders from different refineries at 190-200° C. as a function of time, with the solid bold horizontal lines representing the maximum and minimum TG 1 limits;

FIG. 2-6 shows a photographs of non-flushing (CRM bitumen 1) and flushing (CRM bitumen 2) areas;

FIG. 2-7 shows softening point curves with digestion time of crumb rubber modified bituminous blends or binders at 190-200° C., with the solid bold lines representing the maximum and minimum TG 1 limits;

FIG. 2-8 shows the softening point curves with digestion time of two crumb rubber modified bituminous blends or binders at 190-200° C.;

FIG. 2-9 shows a graph of Jₙᵣ values at 58′C for a base bituminous binder and Jₙᵣ values of the corresponding crumb rubber modified bituminous binder or blend at various digestion time intervals;

FIG. 3-1 shows force ductility curves for a stiffness inducing and an elasticity inducing reactive elastomeric terpolymer;

FIG. 3-2 shows the average molar mass and molar mass distribution curves when a stiffness-inducing reactive elastomeric terpolymer additive is added to an over-digested crumb rubber modified bituminous binder;

FIG. 3-3 shows graphs of the softening point of an over-digested crumb rubber modified bituminous binder or blend before and after addition of a stiffness-inducing reactive elastomeric terpolymer (SI RET) additive in the form of an ethylene/n-butyl acrylate/glycidyl methacrylate composition;

FIG. 3-4 shows Jₙᵣ results at 58′C for an over-digested crumb rubber modified bituminous binder or blend before and after addition of a stiffness-inducing reactive elastomeric terpolymer (SI RET) additive in the form of an ethylene/n-butyl acrylate/glycidyl methacrylate composition;

FIG. 3-5 shows Black diagrams of over-digested crumb rubber modified bituminous binders or blends before and after addition of a stiffness-inducing reactive elastomeric terpolymer (SI RET) additive in the form of an ethylene/n-butyl acrylate/glycidyl methacrylate composition;

FIG. 4-1 shows graphs of average permanent strain accumulation vs. number of load cycles at 40° C., for an SBS mix, a repeat SBS mix, and a re-stiffened over-digested crumb rubber modified bituminous mix (MOD-CR mix); and

FIG. 4-2 shows graphs of average permanent strain accumulation vs. number of load cycles at 40′C, for a crumb rubber modified bituminous mix (CRM Mix) and a re-stiffened over-digested crumb rubber modified bituminous mix (MOD-CR mix).

### DETAILED DESCRIPTION OF THE DISCLOSURE

The inventor believes that although digestion viscosity curves have been used successfully as a production tool, they cannot be used as an indicator of performance of rubber modified bituminous binders because viscosity is tested at much higher handling temperatures not representative of actual field performance at lower in-service temperatures (e.g. temperatures of 20° C.-70° C.). Rheologically, disintegrated rubber polymers from the de-vulcanization of the rubber crumbs present after over-digestion are still capable of imparting elastic properties. Over-digested crumb rubber modified bituminous binder should remain useful for re-blending or continual usage in alternative products given appropriate characterisation. In addition, the potential benefits of liquid non-particulate over-digested crumb rubber modified bituminous binders include ease of handling due to their lower viscosity, ease of blending with bitumen, and energy saving during processing. The challenge is to make sure that oils and/or low molecular weight compounds present in over-digested crumb rubber modified bituminous blends do not reduce the binder stiffness and offset the enhanced elastic properties imparted by the modifier. The inventor thus reviewed earlier studies conducted to investigate the properties of crumb rubber modified bituminous binders (see Mturi GAJ, O'Connell 0.1, Marais H and Hawes N, A Brief Analysis of Over-Digested Crumb Rubber Modified Bitumen, Rubberized Asphalt: Asphalt Rubber Conference (2015) 409-419, Las Vegas, United States of America) and proceeded to propose methods by which over-digested crumb rubber modified bituminous binders can be re-stiffened.

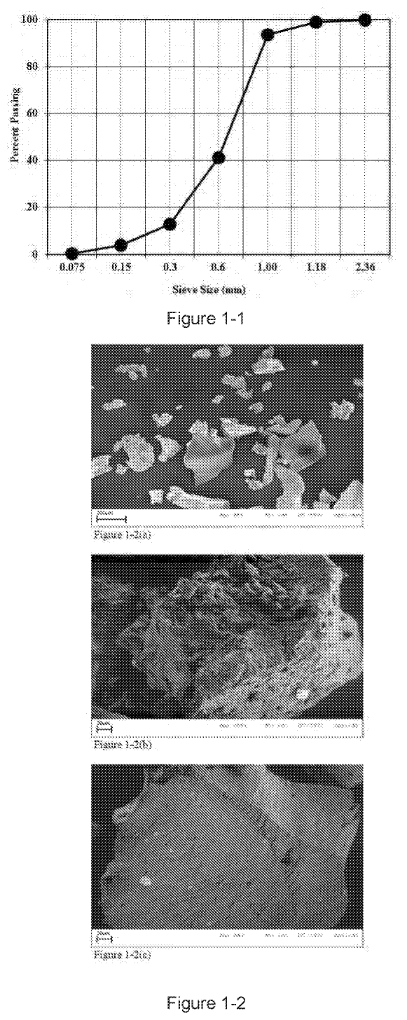

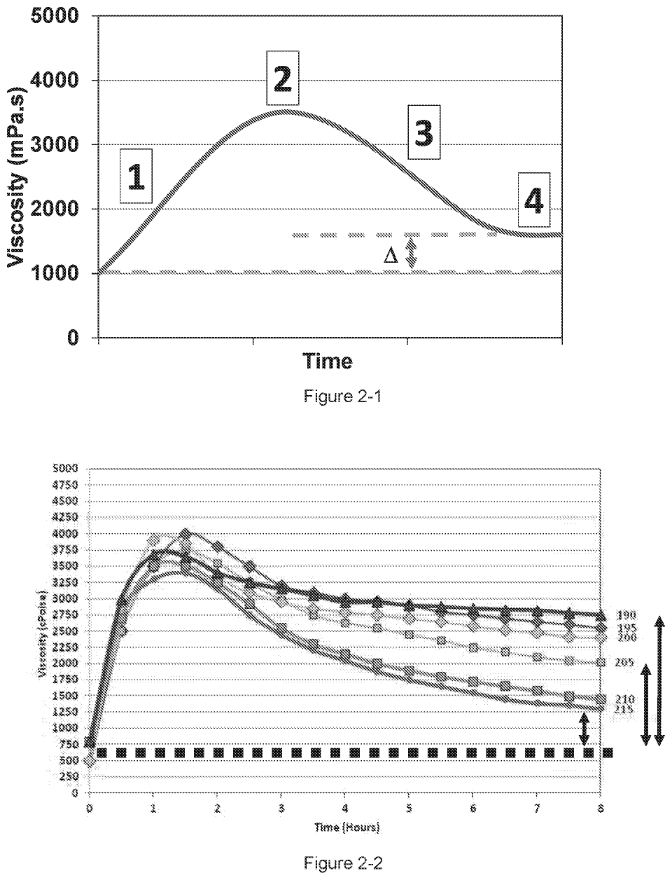

In these studies, the typical 70/100 penetration grade bitumen conforming to SANS 4001-BT1, 2014 was used. An extender oil produced as per the requirements of COLTO, 1998 was used with the bitumen. Rubber crumbs of the grading requirements stated in TG1, 2015 were used. The rubber crumb particles used in the studies essentially pass a 1.00 mm sieve (1.18 mm was the requirement in a previous guideline document i.e. TG1, 2007) and the majority is retained on a 0.6 mm sieve. FIGS. 1-1 and 1-2 (obtained from Mturi, G., Zoorob, S. E., O'Connell, J., Anochie-Boateng, J., & Maina, J. (2011b). Rheological testing of crumb rubber modified bitumen. In Proceedings of the 7th International Committee on Road & Airfield Pavement Technology (pp. 1316-1327). Bangkok, Thailand, paper P18) depict the grading for the rubber crumbs used in this investigation.

The rubber crumb surface texture/morphology is shown in the scanning electron microscope (SEM) photographs of FIG. 1-2(a)-(c). The porous microstructures are consistent with comminution via an ambient process. The white spots seen in FIGS. 1-2(b) and 1-2(c) are most likely filler and not metal fragments since South Africa only imports non-steel reinforced tyres for rubber crumb manufacture (COLTO, 1998). The results for an elemental analysis of the rubber crumbs are shown in Table 1-1. They have a typical composition of carbon, oxygen, silicon, sulphur and traces of the metals, calcium, sodium, aluminium and zinc possibly from a vulcanization component.

TABLE 1-1
Elemental composition (by weight) of the rubber crumbs

| SPECTRUM | C | O | Si | S | Ca | Na | Al | Zn | Total |
|---|---|---|---|---|---|---|---|---|---|
| Sample 1 | 81.93 | 16.60 | | 0.91 | | 0.55 | | | 100.00 |
| Sample 1 Repeat 1 | 76.54 | 23.46 | | | | <0.005 | | | 100.00 |
| Sample 1 Repeat 2 | 86.42 | 11.19 | 0.58 | 1.36 | 0.44 | | | <0.005 | 100.00 |
| Sample 1 Repeat 3 | 85.91 | 11.52 | | 2.08 | | | 0.50 | <0.005 | 100.00 |
| Sample 1 Repeat 4 | 88.71 | 8.02 | 0.75 | 2.03 | | | 0.51 | <0.005 | 100.00 |
| Max. Detected | 88.71 | 23.46 | 0.75 | 2.08 | 0.44 | 0.55 | 0.51 | <0.005 | |
| Min. Detected | 76.54 | 8.02 | 0.58 | 0.91 | 0.44 | <0.005 | 0.50 | <0.005 | |

The test results in Table 1-2 below indicate that crumb rubber modified bituminous blends used in this investigation conformed to South African Technical Guideline 1 guidelines for the A-R1 grade, which is an asphalt grade (TG1, 2015), except that the resilience of crumb rubber modified bituminous binder 1 was slightly above recommendation. The grade S-R1 is a surfacing seal grade. The test methods indicated with an MB in the name of the test method are described in TG1, 2015.

TABLE 1-2
Crumb rubber modified bitumen properties for asphalt (A-R1) and
seals (S-R1) according to South African national guidelines.

| | | | | | | | Class | |
|---|---|---|---|---|---|---|---|---|
| | | | | Results | | Test | (TG1, 2015) | |
| PROPERTY | | | Unit | Binder 1 | Binder 2 | Method | S-R1 | A-R1 |
| Softening Point | | | ° C. | 62.8 | 65.0 | MB-17 | 55-65 | 55-65 |
| Dynamic Viscosity at 190° C. | | | dPa · s | 35 | 45 | MB-13 | 20-40 | 20-50 |
| Compression | 5 | mins | % | 86.6 | 84.6 | MB-11 | >70 | >80 |
| Recovery after | 1 | hour | | 88.6 | 88.6 | | >70 | >70 |
| | 24 | hours | | N/A | 80.7 | | >40 | N/A |

| | | | | | | |
|---|---|---|---|---|---|---|
| Resilience at 25° C. | % | 42 | 32 | MB-10 | 13-35 | 13-40 |
| Flow | mm | 14 | 17 | MB-12 | 15-70 | 10-50 |

The properties of rubber modified bituminous binders change with temperature, digestion time and energy consumed during the digestion process. The various stages (Stages 1 to 4) of crumb rubber modified bituminous blends or binders can be defined in terms of viscosity, as depicted in FIG. 2-1 (obtained from Mturi G. A. J., O'Connell J., Zoorob S., De Beer M., “A study of crumb rubber modified bitumen used in South Africa”, Road Materials and Pavement Design, Vol. 15, Issue 4, 2014, p. 774-790).

Stage 1 is characterised by an initial increase in viscosity upon blending. In this stage, the rubber particle dimension increases as the oil and/or lighter components of the bitumen diffuse into the three-dimensional rubber networks of poly-isoprene and poly-butadiene linked by sulphur-sulphur bonds. The diffusion process varies according to the amount of cross-linkages in the rubber, the molecular compatibility between the rubber and the diffusing particles as well as the molecular weight of the latter. A further incorporation of the diffusing matter into the rubber particles would possibly occur as the sulphur-sulphur bonds start to thermally dissociate and this contributes to an additional increase in viscosity.

The thermal dissociation process continues until a maximum viscosity point, referred to as Stage 2, is reached. The viscosity then decreases with digestion time in Stage 3 as the network disintegrates due to the loss of the sulphur linkages. Once the viscosity reaches the minimum recommended viscosity limit of 20 dPa.s (or 2000 mPa.S) in TG1, 2015, the bitumen rubber is labelled as “over-digested”, at least in South Africa. The decrease in viscosity continues until it reaches a point of relatively constant viscosity where the crumb robber modified bituminous blend is referred to as “terminal”. This has been depicted as Stage 4 in the digestion viscosity curve shown in FIG. 2-1.

The viscosity at Stage 4 is typically higher than the viscosity of the base bituminous binder. This viscosity increase is attributed to ageing (of the base bituminous binder) comingled with the incorporation of digested crumb rubber into the base bituminous binder.

Stage 3 typically represents an application window or period for crumb rubber modified bituminous binders or blends. Lower application temperatures can increase this application window by slowing down the digestion process, as seen in FIG. 2-2 (obtained from Müller J., Marais H., “The Perceived versus actual shelf-life and performance properties of bitumen rubber”, Proceedings of the Asphalt Rubber Conference (Sousa J. B., ed.), 23-26 Oct. 2012, Munich, p. 429-441) where the lower viscosities of Stage 4 are delayed. This has led to the development of warm mix additives to allow for the application of these binders at lower temperatures. However, this adds another complexity in that the effect of these extra constituents on asphalt performance needs to be investigated and controlled in guidelines and specifications.

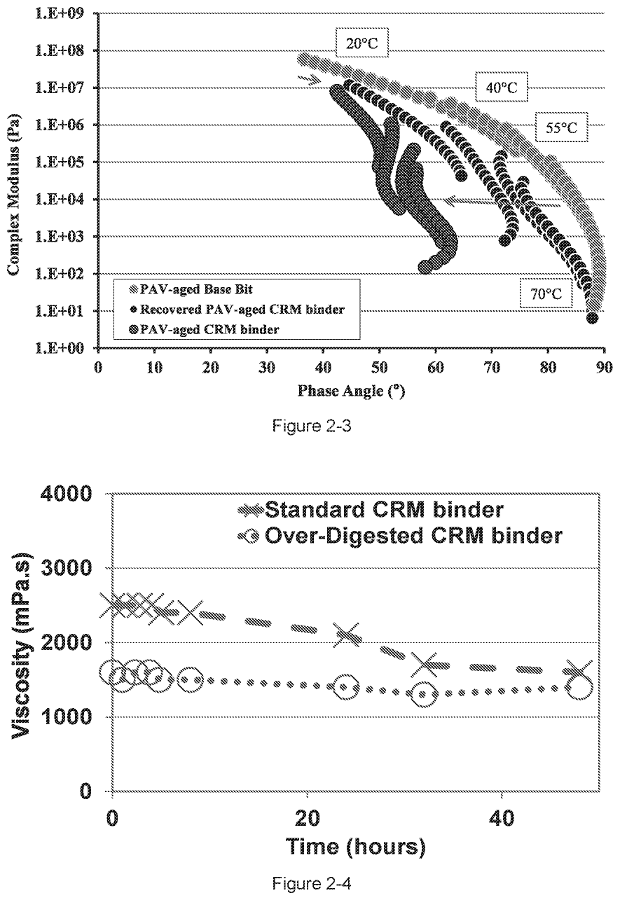

De-vulcanised over-digested crumb rubber modified bituminous binder is potentially less sensitive to handling conditions. The over-digested binder will still be a polymer modified binder and, hence, can give superior performance compared to standard unmodified penetration grade bitumen. It has been shown that significant resilience and elastic properties remain even after 32 hours of over-digestion for South African crumb rubber modified bituminous blends. This is confirmed through the analysis of PAV-aged (pressure aging vessel aged) crumb rubber modified bituminous binders (CRM binder) in FIG. 2-3 (obtained from Mturi, G. A. J., O'Connell, J., & Anochie-Boateng, J. K. (2013). Limitations of current South African test methods for bituminous binders. Construction and Building Materials, 45, 314-323) which were shown to still exhibit a certain degree of elastic properties. FIG. 2-3 also shows the recovered PAV-aged crumb rubber modified bituminous binder displaying elastic properties without the solvent insoluble crumb rubber. This is due to the increased incorporation (as a consequence of ageing/digestion) of de-linked polymers of the crumb rubber into the solvent-soluble bitumen.

Over-digestion results in a decrease in viscosity, so previous investigators (O'Connell J., Anochie-Boateng J., Marais H., “Evaluation of bitumen-rubber asphalt manufactured from modified binder at lower viscosity”, Proceedings of the 29th Southern African Transport Conference, 16-19 Aug. 2010, Pretoria, p. 129-138) investigated two crumb rubber modified bituminous blends, one conforming to TG 1 guideline requirements and the other over-digested such that the viscosity is below the current range in the TG 1 guideline. The digestion viscosity curves of the two crumb rubber modified bituminous blends or binders (CRM binders) are shown in FIG. 2-4. Both blends do not show significant viscosity changes during the short-term digestion conditions. The standard crumb rubber modified bituminous binder has viscosities within the set TG 1 limits (i.e. above 2000 mPa.S) up to 20 hours of digestion. Over-digestion during asphalt manufacture is therefore unlikely, and this binder would be expected to show relatively superior and acceptable performance in an asphalt mix.

The two blends were incorporated in a standard medium continuously graded asphalt mix design and evaluated as per SABITA Manual 19, Guidelines for the design, manufacture and construction of bitumen rubber asphalt wearing courses, SABITA, Howard Place, South Africa, 2009 (hereinafter referred to as SABITA Manual 19, 2007). The mix design method was specifically developed for these crumb rubber modified bituminous binders. Interestingly, both crumb rubber modified asphalt mixes gave much poorer results from the expected performance and even inferior compared to a 50/70 penetration medium continuously graded asphalt mix (see Table 3-1). The crumb rubber modified asphalt mixes gave low Indirect Tensile Strength (ITS) and Marshall Stability test results with higher flow test values indicating increased susceptibility to deformation. The two crumb rubber modified asphalt mixes had similar gradings and the better performance of the standard crumb rubber modified bituminous binder was interestingly the higher viscosity binder.

TABLE 3-1
Properties of medium continuous (MC) mix at optimum binder content

| | Standard | Standard crumb | Low viscosity | |
|---|---|---|---|---|
| | 50/70 | rubber modified | crumb rubber | SABITA |
| | penetration | bituminous | modified | Manual 19, |
| Properties | bitumen | binder | bituminous binder | 2007 |
| Marshall | 10.4 | 6.8 | 5.8 | 8 minimum |
| Stability (kN) | | | | |
| Marshall Flow | 4.1 | 5.1 | 6.0 | 2-5 |
| (mm) | | | | |
| ITS (kPa) | 676 | 317 | 293 | 600 minimum |
| Average voids | 5.7 | 3.3 | 4.2 | 2-6 |
| (%) | | | | |

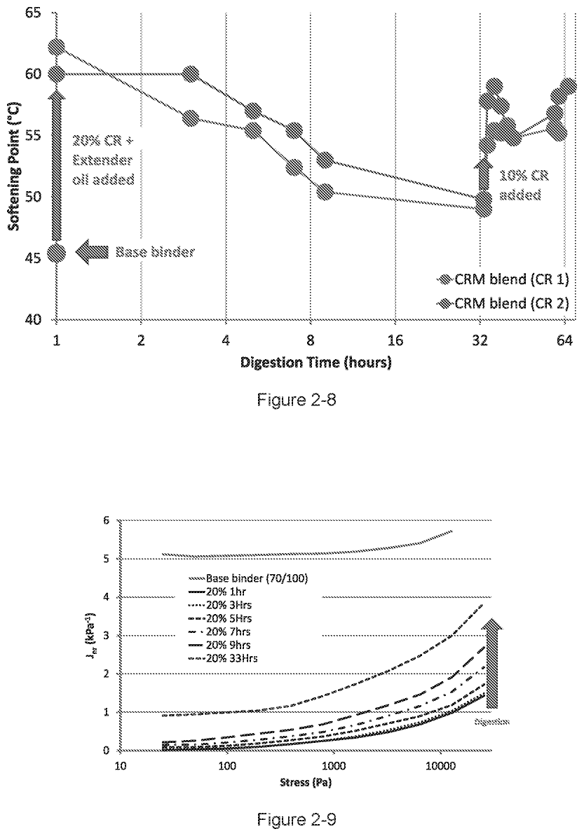

Mturi et al. (Mturi, G., Conrad, S., & Mogonedi, K. (2011). JR 5023: Analysis of Modified Binders used in Seal Application as a Possible Cause of Observed Highway Distresses (Technical Report No: CSIR/BE/IE/MEMO/2011/0003/B). South Africa: CSIR) also prepared two crumb rubber modified bituminous binders or blends (referred to as CRM Bitumen 1 and CRM Bitumen 2 in FIG. 2-5) using the same crumb rubber and blending method as O'Connell et al. but with different base bituminous binders from two separate refineries. It was noted that “the viscosity of the CRM blends conformed to the recommended viscosity range after 6-7 hours of mixing at 190-200° C. (i.e. 6-7 hours from the point referred to as 0 hour), see FIG. 2-5. The blends stayed in this viscosity range for a limited time frame before falling below the minimum required viscosity limit of 2000 mPa·s.

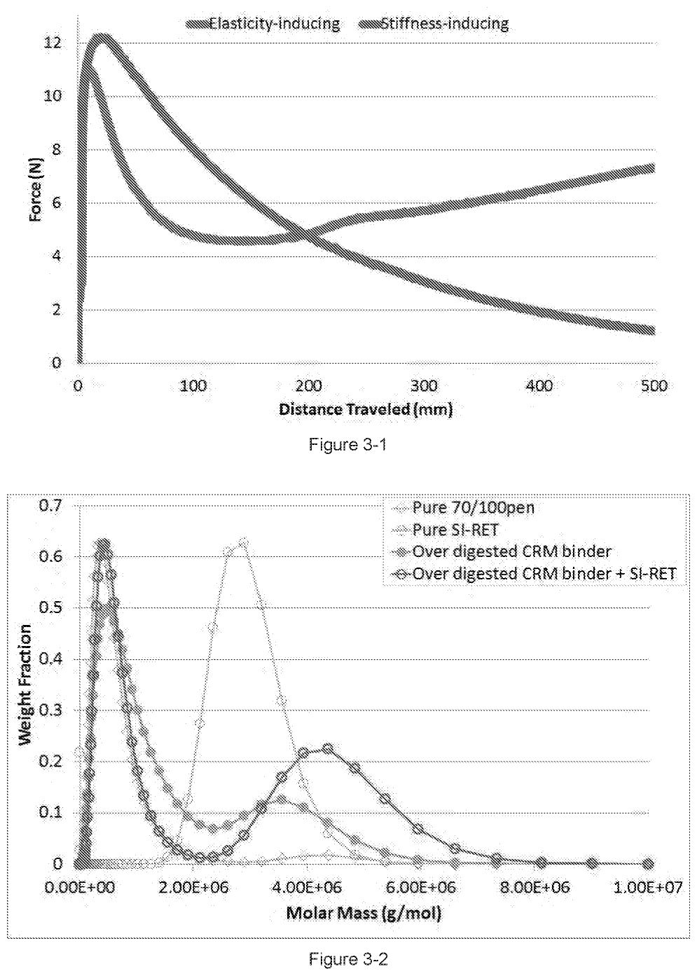

Although the two blends displayed similar digestion curves, they still showed different field performance when used for surfacing seals. The one binder (CRM Bitumen 2 of FIG. 2-5) was a lot softer in the field resulting in flushing and atypical stone orientation (see FIG. 2-6).

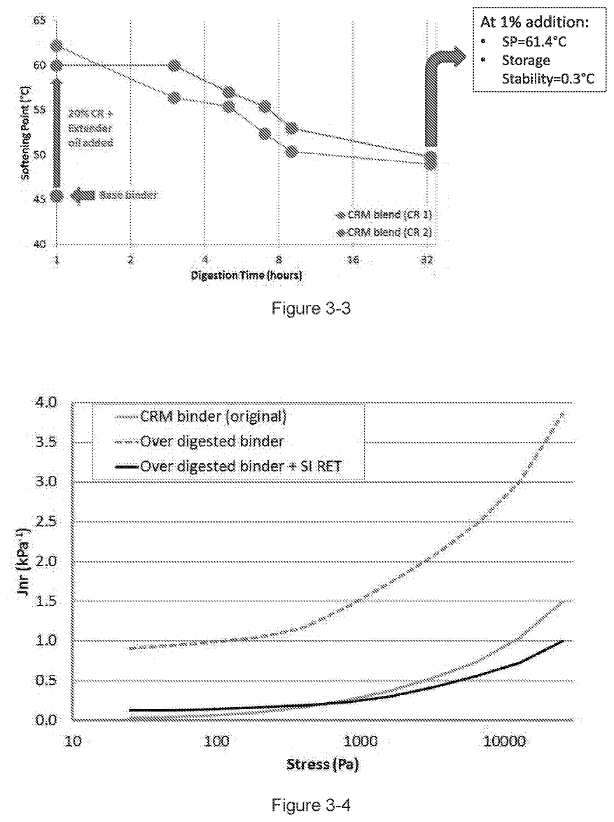

FIG. 2-7 shows softening points with digestion of the same two binders (CRM Bitumen 1 and CRM Bitumen 2) shown in FIG. 2-5. Upon blending, the blend used in the non-flushing area (CRM Bitumen 1) had a much higher softening point than the required TG 1(2007) maximum limit. In contrast, the softening point of the blend from the flushing area (CRM Bitumen 2) (following blending) conformed to the set maximum criterion. After 6-7 hours of digestion, the softening point of the flushing area blend fell below the minimum specification limit. This is precisely the time the blend conformed to the required application viscosity range in FIG. 2-5. So if a contractor waited for the blend viscosity to reach the recommended range, this would explain the softer binder experienced in the field that could have contributed to the observed distress. Mturi et al. however acknowledged that other factors may have also played a role in the observed distress. It is to be noted that the softening point of the non-flushing area blend conformed to the required limits from 6-7 hours of digestion up to 30 hours of digestion.

It can be concluded that the use of digestion viscosity curves to predict performance of crumb rubber modified bituminous binders may be misleading because viscosity is tested at much higher handling temperatures (190-200° C.) which may not be simulative of field performance (e.g. in an asphalt pavement) at in-service temperatures (<70° C.).

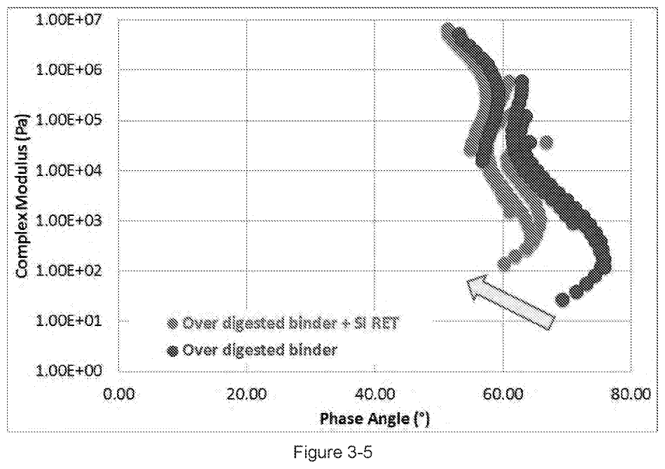

FIG. 2-8 illustrates softening points with digestion of crumb rubber modified bituminous blends (CRM blend (CR1) and CRM blend (CR2)), re-blended with additional crumb rubber (CR) once over-digested. For this exercise, two different types of crumb rubber were used while keeping the rest of the material/process parameters constant. The figure shows softening points of the crumb rubber modified bituminous blends approaching that of the base bituminous binder with over-digestion. Once the blends were supplemented with extra crumb rubber, the over-digested binder regained the higher softening point values and retained them with prolonged digestion.

Notably, the minimum softening points of the two over-digested crumb rubber modified bituminous blends and of the two re-blends (with digestion) were relatively similar, even though the digestion curves for the two crumb rubber types appeared slightly different. It can be considered that the softening points of the base bituminous binder and the over-digested bituminous binder (considered the base binder of the re-blend) act as limits preventing any further drop in softening points with continued digestion. This proves that the properties of the base binder are just as important in the manufacture of crumb rubber modified bituminous binders and can also be specified according to climatic conditions.

Crumb rubber modified bituminous binder residues taken at various digestion time intervals were analysed for their stress sensitivity (i.e. sensitivity to traffic loading). The test method employed is referred to as the multiple stress creep and recovery (MSCR) test. The MSCR test as per ASTM D7405 or AASHTO T350 evaluates the ability of binders to maintain elastic response at the stress levels of 100 Pa and 3200 Pa using a dynamic shear rheometer (DSR). The test involves applying a 1-second creep loading followed by a 9-second recovery phase, and this constitutes a single cycle. At each stress level, 10 creep and recovery cycles are applied. The modified test procedure adopted for this investigation uses multiple stress levels of 25, 50, 100, 200, 400, 800, 1600, 3200, 6400, 12800 and 25600 Pa. The average non-recovered strain (ynr) for the 10 creep and recovery cycles is then divided by the applied stress (T) for those cycles yielding the non-recoverable creep compliance (Jₙᵣ=γnr/ti). The accumulation of Jₙᵣ over time will eventually lead to permanent deformation.

The MSCR test was modified to adopt multiple stress loading conditions because an in situ binder in an asphalt layer experiences a wide range of stresses from the passing of light to heavy vehicles. It is the higher stresses experienced under repetitive heavy vehicle loads that would eventually be responsible for pavement deformation. Therefore, it is at higher stress loading conditions that binders are better evaluated in terms of their damage resistance properties.

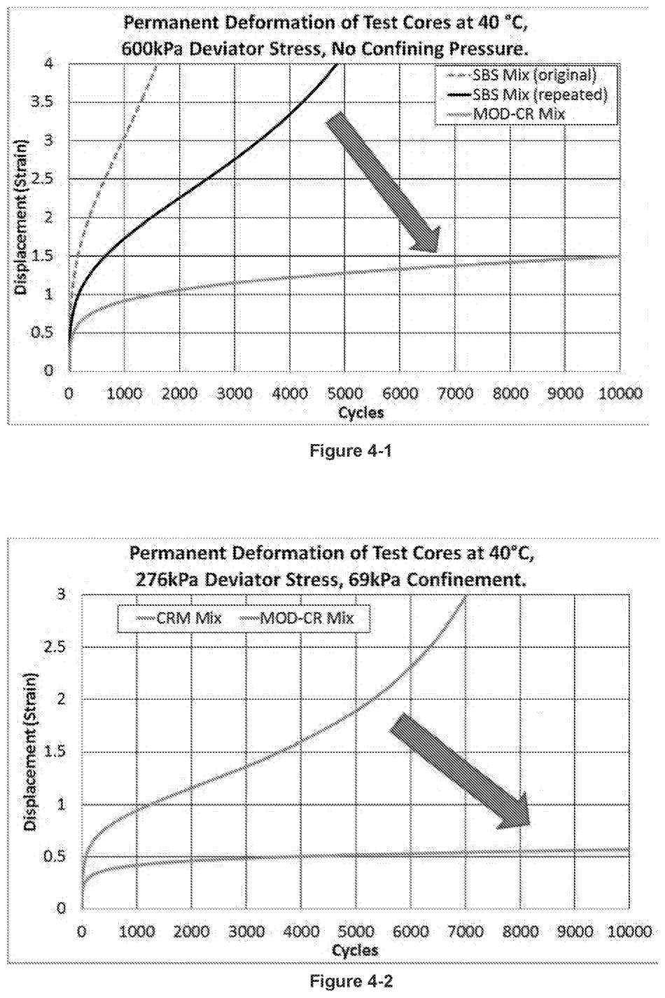

FIG. 2-9 shows the MSCR test results of the crumb rubber modified bituminous binders or blends. The test results graphically illustrated in FIG. 2-9 show that the drop in crumb rubber modified bituminous binder or blend stiffness expected with digestion time is accompanied by an increase in stress sensitivity. Re-stiffening the over-digested crumb rubber modified bituminous binder with a modifier or additive should therefore be assessed as to whether it also improves stress resilience.

It is important to note that the behaviour observed in FIGS. 2-8 and 2-9 applies to the particular crumb rubber modified bituminous blends tested. This behaviour would need to be repeated and confirmed with other crumb rubber modified bituminous blends accordingly.

The foregoing investigations have shown that in order to make an over-digested crumb rubber modified bituminous binder useful again, re-stiffening the over-digested crumb rubber modified bituminous binder should specifically improve:
(1) In-service properties (such as softening point instead of viscosity at 190° C.),
(2) Stress resilience, and
(3) Stability.

An ideal additive should recreate a network to recombine lower molecular weight oily constituents and consequently improve stiffness and storage stability properties of an over-digested crumb rubber modified bituminous binder. An investigation with a range of additives came up with the following findings:
Temporary network forming non-reactive additives (e.g. fillers, styrene-butadiene-styrene, etc.) were found unsuitable because they increased the stress sensitivity of over-digested crumb rubber modified bituminous binders.
Reactive additives improved the stress resilience properties of over-digested crumb rubber modified bituminous binders.
Elasticity-inducing additives (e.g. terpolymers containing butyl acrylate at 28 wt % and glycidyl methacrylate at 5.3 wt %) had very little effect on stiffness properties of over-digested crumb rubber modified bituminous binder.
Stiffness-inducing additives (e.g. ethylene-vinyl acetate) had the highest effect on the stiffness of over-digested crumb rubber modified bituminous binders. Ethylene-vinyl acetate is however non-reactive in bituminous blends.

Based on the investigations which the inventor was involved with, and the conclusions reached, the inventor decided that reactive elastomeric terpolymers (referred to as SI(RET) below), e.g. a terpolymer of ethylene, alkyl acrylate and glycidyl methacrylate (GMA) would be ideally suited for re-stiffening an over-digested crumb rubber modified bituminous binder. The inventor believes that the GMA group would react with available functional groups as it reacts (supposedly) with carboxylic functional groups in bituminous asphaltenes fractions:

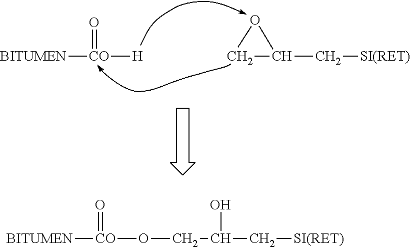

Force ductility curves of modified penetration grade bitumens however showed that only specific terpolymer formulations were highly reactive and hence sufficiently stiffness-inducing (as opposed to elasticity-inducing) for purposes of re-stiffening an over-digested crumb rubber modified bituminous binder sufficiently (see FIG. 3-1).

The addition of stiffness-inducing reactive elastomeric terpolymer to form polymer linkages with the over-digested crumb rubber modified bituminous binder (over digested CRM binder) was monitored through average molar mass and molar mass distribution determination, as shown in FIG. 3-2. In this particular case, the stiffness-inducing reactive elastomeric terpolymer additive (SI RET) used was an ethylene/n-butyl acrylate/glycidyl methacrylate terpolymer (at 9% GMA). FIG. 3-2 also shows the molar mass distribution of pure 70/100 penetration grade bitumen (Pure 10/100pen).

The crumb rubber modified bituminous binder was prepared at temperatures between 190-200° C. on a hot plate with a 4 bladed stainless-steel propeller (paddle stirrer) at a speed of 1500-2000 rpnn. The crumb rubber modified bituminous binder was maintained at this temperature until complete over digestion, notably where stable/consistent properties were achieved after 32-33 hours of stirring. 1% (nn/nn) SI RET additive was added to the over-digested blend without changing the stirring speed. The sample was stirred for a further 2 hours continuously. All blends were checked periodically and adjustments to the stirrer position done as the viscosity changed.

There was no addition of poly-phosphoric acid (PPA). When added alone or in combination with the SI RET additive, PPA was found negatively to affect the properties of the bituminous binder.

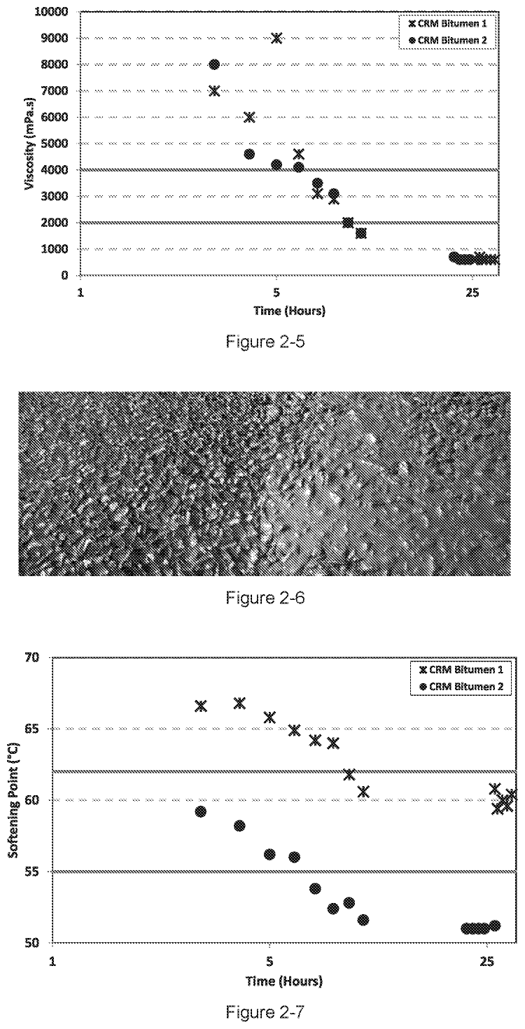

The SI RET additive increased the softening point (SP) of the over-digested binder (CRM blend (CR 1)) to a level similar to the original crumb rubber (CR) modified bituminous blend or binder. It also improved the storage stability of the re-stiffened blend as shown in FIG. 3-3. The stiffness-inducing reactive elastomeric terpolymer additive and crumb rubber modified bituminous blend (over digested binder+SI RET) also exhibited improved stress resilience as shown in FIG. 3-4 which shows graphs for the original crumb rubber modified bituminous binder (CRM binder (original)), the over-digested crumb rubber modified bituminous binder (over digested binder) and the stiffness-inducing reactive elastomeric terpolymer additive and crumb rubber modified bituminous blend (Over digested binder+SI RET), and increased stiffness and reduced elastic properties at high in-service temperatures (see FIG. 3-5), when compared with over-digested crumb rubber modified bituminous binder (over digested binder). Based on TG1 (2015) guideline recommendations, the stiffness-inducing reactive elastomeric terpolymer additive and crumb rubber modified bituminous blend was found conforming to both A-R1 (for asphalt) and S-R1 (for seals) classes for all tested properties except viscosity at 190′C (as expected given it was over-digested), as shown in Table 3-1.

TABLE 3-1
TG1 (2015) properties of over-digested crumb rubber modified
bituminous binder re-stiffened with a stiffness-inducing
reactive elastomeric terpolymer (SI RET) additive.

| | | | | | | Class | |
|---|---|---|---|---|---|---|---|
| | | | | | Test | (TG1, 2015) | |
| PROPERTY | | | Unit | Results | Method | S-R1 | A-R1 |
| Softening Point | | | ° C. | 61.0-61.4 | MB-17 | 55-65 | 55-65 |
| Dynamic Viscosity at | | | dPa · s | 8.0 | MB-13 | 20-40 | 20-50 |
| 190° C. | | | | | | | |
| Compression | 5 | mins | % | 85.6 | MB-11 | >70 | >80 |
| Recovery After | 1 | hour | | 85.6 | | >70 | >70 |
| | 24 | hours | | 69.9 | | >40 | N/A |
| | 4 | days | | 67.9 | | N/A | N/A |

| | | | | | |
|---|---|---|---|---|---|
| Resilience at 25° C. | % | 17.3 | MB-10 | 13-35 | 13-40 |
| Flow | mm | 28 | MB-12 | 15-70 | 10-50 |

The stiffness-inducing reactive elastomeric terpolymer additive and crumb rubber modified bituminous blend or binder (re-stiffened binder) was investigated against a crumb rubber modified bituminous binder and a styrene-butadiene-styrene (SBS) modified bituminous binder in terms of permanent deformation resistance in asphalt mixes. Asphalt mixes were prepared using typical optimized mix designs used for road construction in South Africa, namely a bitumen rubber asphalt semi-open graded mix (BRASO) and a medium continuously graded mix (A-E2 SBS).

The mixing and compaction of specimens were done in accordance with CSIR test protocols. The mixes were prepared using a heated mechanical mixer into which the calculated masses of aggregate and bituminous binder were placed. Aggregates were blended in accordance with the design grading. The materials were mixed for approximately 5 minutes or until a uniform mixture was obtained. After mixing, the material was placed in an oven set at compaction temperature for four hours to induce short-term ageing, after which the mix was compacted. Gyratory specimens for performance testing were compacted to a density of between 92 and 94 percent of the Maximum Theoretical Relative Density (MTRD). The resultant cored gyratory specimens were used to perform a repeated load permanent deformation (RLPD) test.

The medium continuously graded mixes were prepared at the CSIR advanced road material testing laboratories using a standard SBS binder and an over-digested crumb rubber modified bituminous binder comprising SI RET additive (i.e. re-stiffened binder). Air voids and binder contents in the laboratory testing programme simulated the properties of the field mixes as best as possible. The original design was done using the Marshall Mix design method as per COLTO (1998) with the Interim Guidelines for the Design of Hot Mix Asphalt (2001). Table 4-1 shows the target binder and air voids contents as well as other volumetric properties of the mix.

After compaction, the densities (MTRD and BRD) were determined using the standard TMH1 C3 method. The results for the specimens tested are shown in Tables 4-2 and 4-3 for the SBS mix (specimen 14383) and the re-stiffened binder (specimen 14706). The voids content for the performance tests specimens were within 6% to 8% voids content.

TABLE 4-1
Summary of volumetric properties of the medium continuous mix

| Mix property | Design value | |
|---|---|---|
| Binder content (%) | 4.7% | |
| Design air voids (%), saturation surface dry (SSD) | 4.6% | |
| VMA (%) | 15.9% | |
| VFB (%) | 70.5% | |
| Compaction temperature | 145° | C. |
| Mixing temperature | 160-170° | C. |

TABLE 4-2
Gyratory specimens' densities (before
and after coring) for the SBS mix

TMH1 C3 BRD

| Specimen no. | MTRD | BRD | Voids (%) |
|---|---|---|---|
| 14383-G4C | 2.721 | 2.554 | 6.1 |
| 14383-G5C | 2.721 | 2.551 | 6.2 |
| 14383-G6C | 2.721 | 2.556 | 6.1 |
| 12651G26C* | 2.669 | 2.490 | 6.6 |
| 12651G27C* | 2.669 | 2.485 | 7.0 |
| 12651G28C* | 2.669 | 2.489 | 6.6 |
| 12651G24C* | 2.669 | 2.495 | 6.5 |
| 12651G30C* | 2.669 | 2.484 | 7.1 |
| 12651G31C* | 2.669 | 2.477 | 7.0 |

*Original mix results produced in the development of the SABITA Asphalt Mix Design Manual for South Africa (2014) (SABITA Draft Manual, Asphalt mix design manual for South Africa - provisional working document, SABITA, Howard Place, South Africa, 2014).

TABLE 4-3
Gyratory specimens' densities (before
and after coring) for the re-stiffened binder

TMH1 C3 BRD

| Specimen no. | MTRD | BRD | Voids (%) |
|---|---|---|---|
| 14706-G4C | 2.720 | 2.514 | 7.6 |
| 14706-G5C | 2.720 | 2.508 | 7.8 |

Based on AASHTO TP 79 (2009) and NCHRP Report 702 (2011), the rutting resistance behaviour of the mixes was investigated. The UTM-25 test setup for dynamic modulus testing was used to conduct the test. Gyratory compacted specimens size of 100 mm diameter and 150 mm high cored from cylindrical medium continuous specimens of 150 mm in diameter by 170 mm high were tested.

The permanent deformation experimental design consisted of a single applied stress (deviator stress) level of 600 kPa at 40° C. The deviator stress was repeatedly pulsed in the vertical direction on the specimens using a haversine pulse load of 0.1 seconds and 0.9 seconds rest period until flow or 10,000 load cycles.

Table 4-4 shows a summary of the test results that includes specimen air voids content, test temperatures, and the loading conditions. Specimens were tested at close to field voids. FIG. 4-1 shows the average permanent strain accumulations in the test samples against the number of load applications at the applied deviator stress level of 600 kPa and test temperature of 40° C.

The re-stiffened over-digested crumb rubber modified bituminous mix (MOD-CR Mix) showed better permanent deformation resistance than the SBS mixes (both the original SBS Mix used with this mix design and the repeated SBS Mix manufactured for this exercise) at the tested temperature.

TABLE 4-4
Summarized loading conditions and results of repeated load test

| | | | | | | | Strain | |
|---|---|---|---|---|---|---|---|---|
| | | Test | Cyclic | Cycles | | Max | at | Permanent |
| Sample | Voids | Temp. | Stress | to | Flow | Displacement | flow point | Deformation at |
| ID | (%) | (° C.) | (kPa) | Termination | Number | (mm) | strain | flow point |
| 12651G26C* | 6.6 | 40 | 600 | 10000 | 945 | 7.332 | 3.720 | 5.455 |
| 12651G27C* | 7.0 | 40 | 600 | 10000 | 982 | 7.441 | 3.080 | 4.583 |
| 12651G28C* | 6.6 | 40 | 600 | 10000 | 697 | 7.428 | 2.872 | 4.266 |
| 12651G24C* | 6.5 | 40 | 600 | 10000 | 1156 | 7.423 | 3.117 | 4.626 |
| 12651G30C* | 7.1 | 40 | 600 | 10000 | 1587 | 7.365 | 3.042 | 4.481 |
| 12651G31C* | 7.0 | 40 | 600 | 10000 | 1377 | 7.408 | 2.865 | 4.244 |
| 14383-G4C | 6.1 | 40 | 600 | 10000 | 1569 | 7.575 | 1.880 | 2.848 |
| 14383-G5C | 6.2 | 40 | 600 | 10000 | 1947 | 7.547 | 2.327 | 3.511 |
| 14383-G6C | 6.1 | 40 | 600 | 10000 | 1960 | 7.540 | 2.327 | 3.509 |
| 14706-G4C | 7.6 | 40 | 600 | 10000 | 5716 | 1.641 | 1.146 | 1.725 |
| 14706-G5C | 7.8 | 40 | 600 | 10000 | 8655 | 2.574 | 1.651 | 2.484 |

*Original mix results produced in the development of the SABITA Asphalt Mix Design Manual for South Africa (2014).

The BRASO mixes were prepared at the CSIR advanced road material testing laboratories using a standard crumb rubber modified bituminous binder and an over-digested crumb rubber modified bituminous binder comprising SI RET additive (i.e. re-stiffened binder). Air voids and binder contents in the laboratory-testing programme simulated the properties of the field mixes as best as possible. The original design was done using the Marshall mix design method as per SABITA Manual 19, 2007 with the Interim Guidelines for the Design of Hot Mix Asphalt (2001). Table 4-5 shows the target binder and air voids contents as well as other design properties of the mix.

TABLE 4-5
Summary of volumetric properties of the mix

| Mix property | Design value | |
|---|---|---|
| Binder content (%) | 7.5% | |
| Design air voids (%), saturation surface dry (SSD) | 5.6% | |
| VMA (%) | 21.6% | |
| VFB (%) | 74.3% | |
| Compaction temperature | 140-145° | C. |
| Mixing temperature | 170° | C. |

After compaction, the densities (MTRD and BRD) were determined using the standard TMH1 C3 method. The results for the specimens tested are shown in Tables 4-6 and 4-7 for the crumb rubber modified bituminous mix (specimen 14536) and the re-stiffened mix respectively (specimen 14697). The voids content for the performance tests specimens were within 6% to 8% voids content.

TABLE 4-6
Gyratory specimens densities (before and after
coring) for the crumb rubber modified mix

TMH1 C3 BRD

| Specimen no. | MTRD | BRD | Voids (%) |
|---|---|---|---|
| 14536 G11C* | 2.455 | 2.289 | 6.8 |
| 14536 G4** | 2.432 | 2.285 | 6.0 |
| 14536 G5** | 2.432 | 2.261 | 7.0 |

*Lab sample (prepared at the CSIR)
**Plant sample

TABLE 4-7
Gyratory specimen's densities (before
and after coring) for the re-stiffened mix

TMH1 C3 BRD

| Specimen no. | MTRD | BRD | Voids (%) |
|---|---|---|---|
| 14697 G2C | 2.475 | 2.288 | 7.6 |
| 14697 G3C | 2.475 | 2.287 | 7.6 |
| 14697 G4C | 2.475 | 2.288 | 7.6 |

Based on AASHTO TP 79 (2009) and NCHRP Report 702 (2011), the rutting resistance behaviour of the mixes was investigated. The UTM-25 test setup for dynamic modulus testing was used to conduct the test. Gyratory compacted specimens size of 100 mm diameter and 150 mm high cored from cylindrical medium continuous specimens of 150 mm in diameter by 170 mm high were tested.

The permanent deformation experimental design consisted of a single applied stress (deviator stress) level of 276 kPa and 69 kPa confinement pressure at 40° C. The deviator stress was repeatedly pulsed in the vertical direction on the specimens using a haversine pulse load of 0.1 seconds and 0.9 seconds rest period until flow or 10,000 load cycles.

Table 4-8 shows a summary of the test results that include specimen air voids content, test temperatures, and the loading conditions. Specimens were tested at close to field voids. FIG. 4-2 shows the average permanent strain accumulations in the test samples against the number of load applications at the applied deviator stress level of 276 kPa with a confining pressure of 69 kPa and test temperature of 40° C.

The re-stiffened over-digested crumb rubber modified bituminous mix showed better permanent deformation resistance than the standard crumb rubber modified bituminous mix at the tested temperature.

TABLE 4-8
Summarized loading conditions and results of repeated load test

| | | | | | | | | Strain | Permanent |
|---|---|---|---|---|---|---|---|---|---|
| | | Test | Cyclic | Confining | Cycles | | Max | at | Deformation |
| Sample | Voids | Temp. | Stress | Pressure | to | Flow | Displacement | flow point | at flow |
| ID | (%) | (° C.) | (kPa) | (kPa) | Termination | Number | (mm) | strain | point |
| 14536 G11C | 6.8 | 40 | 276 | 69 | 10000 | 2875 | 7.488 | 1.088 | 1.629 |
| 14536 G4 | 6.0 | 40 | 276 | 69 | 10000 | 4179 | 3.466 | 1.425 | 2.127 |
| 14536 G5 | 7.0 | 40 | 276 | 69 | 10000 | 1429 | 7.481 | 1.272 | 1.903 |
| 14697-G2C | 7.6 | 40 | 276 | 69 | 10000 | 8751 | 0.836 | 0.549 | 0.822 |
| 14697-G3C | 7.6 | 40 | 276 | 69 | 10000 | 7442 | 1.059 | 0.683 | 1.021 |
| 14697-G4C | 7.6 | 40 | 276 | 69 | 10000 | 8237 | 0.656 | 0.424 | 0.633 |

The disclosure, as illustrated, provides a method to re-stiffen over-digested rubber modified bituminous binders or blends. Over-digested rubber modified bituminous blends re-stiffened with a stiffness-inducing reactive elastomeric terpolymer additive advantageously produced stiffer, stable and stress resilient homogeneous modified blends.

Larger volumes of re-stiffened bituminous binders were successfully manufactured and incorporated into Hot Mix Asphalt (HMA) designs. The resulting re-stiffened asphalt binder mixes, when compared with standard binders (namely crumb rubber modified bituminous binders and SBS modified bituminous binders) in identical asphalt mix designs containing the same aggregate, grading and binder content, showed superior performance against the standard mixes in terms of rutting resistance from a performance-related laboratory test.

1. A method of re-stiffening an over-digested crumb rubber modified bituminous binder, wherein the over-digested crumb rubber modified bituminous binder is a crumb rubber modified bituminous binder with a viscosity at 190° C. of less than 2000 mPa·s and/or with a softening point of less than 55° C., the method comprising:
Admixing a reactive, stiffness inducing organic additive with the over-digested crumb rubber modified bituminous binder to produce a re-stiffened overdigested crumb rubber modified bituminous binder with an increased softening point,
wherein the admixing takes place at an elevated temperature of at least 185° C.,
wherein the stiffness inducing organic additive and the over-digested crumb rubber modified binder are admixed in a mass ratio of between 0.5:99.5 and 2.0:98.0, and
wherein the reactive, stiffness inducing organic additive is a terpolymer of ethylene, an alkyl acrylate and glycidyl methacrylate.

2. The method according to claim 1, wherein -the over-digested crumb rubber modified bituminous binder is completely over-digested so that the over-digested crumb rubber modified bituminous binder has a viscosity approaching that of a base bituminous binder of the crumb rubber modified bituminous binder, once the viscosity has dropped below 2000 mPa·s, and/or so that the over-digested crumb rubber modified bituminous binder has a softening point approaching that of the base binder, once the softening point has dropped below 55° C.

3. The method according to claim 2, further comprising:
digesting the over-digested crumb rubber modified bituminous binder for a period of time sufficient to ensure that the over-digested crumb rubber modified bituminous binder is completely over-digested prior to admixing the reactive, stiffness inducing organic additive with the over-digested crumb rubber modified bituminous binder.

4. The method according to claim 1, wherein the reactive, stiffness inducing organic additive is reactive so that reactions between one or more components of the reactive, stiffness inducing organic additive with functional groups present in the over-digested crumb rubber modified bituminous binder take place 7 to produce a re-stiffened overdigested crumb rubber modified bituminous binder with an altered composition and an increased softening point.

5. The method according to claim 1, wherein the reactive, stiffness inducing organic additive is reactive so that reactions between one or more components of the reactive, stiffness inducing organic additive with functional groups present in the over-digested crumb rubber modified bituminous binder take place to produce a re-stiffened overdigested crumb rubber modified bituminous binder with an improved Jₙᵣ, and/or an improved storage stability and/or an improved stress resilience.

6. The method according to claim 1,
wherein the admixing is performed at an elevated temperature of between 185° C. and 210° C., and/or
wherein the admixing is for less than 160 minutes and at least for 100 minutes.

7. The method according to claim 1, wherein the stiffness inducing organic additive and the over-digested crumb rubber modified binder are admixed in a mass ratio of between 0.5:99.5 and 1.5:98.5.

8. The re-stiffened overdigested crumb rubber modified bituminous binder produced by the method according to claim 1.

9. The re-stiffened overdigested crumb rubber modified bituminous binder according to claim 8, comprising:
an increased softening point to at least 56° C.

10. The re-stiffened overdigested crumb rubber modified bituminous binder according to claim 8, comprising
a reduction in elasticity with an increase in a complex modulus (G*), as evidenced by reduced phase angles at in-service temperatures.

11. The re-stiffened overdigested crumb rubber modified bituminous binder according to claim 8, comprising:
a compression recovery at 5 minutes, according to the MB-11 test method as set out in TG 1, 2015, of more than 70%, or
a compression recovery after 1 hour, according to the MB-11 test method, of more than 70%, or
a compression recovery after 24 hours, according to the MB-11 test method, of more than 40%, or
a compression recovery after 4 days, according to the MB-11 test method, of more than 40%.

12. The re-stiffened overdigested crumb rubber modified bituminous binder according claim 8, comprising:
a resilience at 25° C., according to the MB-10 test method as set out in TG 1, 2015, of more than 13%.

13. The re-stiffened overdigested crumb rubber modified bituminous binder according to claim 8, wherein the re-stiffened overdigested crumb rubber modified bituminous binder flows, according to the MB-12 test method as set out in TG 1, 2015, more than 10 mm.

14. The re-stiffened overdigested crumb rubber modified bituminous binder according to claim 8, comprising:
a weight fraction of at least 0.13 of components with an average molar mass between 3.9×10⁶ g/mol and 4.1×10⁶ g/mol.

15. The re-stiffened overdigested crumb rubber modified bituminous binder according to claim 8, comprising:
a weight fraction of at least 0.13 of components with an average molar mass between 4.1×10⁶ g/mol and 4.2×10⁶ g/mol.

16. The re-stiffened overdigested crumb rubber modified bituminous binder according to claim 8, comprising:
reaction products from reactions between glycidyl methacrylate and functional groups of the over-digested bituminous binder.

17. A method of sealing or asphalt paving a surface, the method comprising:
applying a layer that includes the re-stiffened overdigested crumb rubber modified bituminous binder of claim 8 to the surface.

18. The method according to claim 17,
wherein the layer includes aggregate particles, and
wherein the re-stiffened overdigested crumb rubber modified bituminous binder and the aggregate particles forming a seal surfacing layer or a layer of an asphalt mix.

19. The method to claim 18, wherein the asphalt mix is a medium continuously graded mix and has a maximum displacement, using a Universal Testing Machine (UTM-25) test setup for dynamic modulus testing, with gyratory compacted specimens size of 100 mm diameter and 150 mm high cored from cylindrical medium continuous specimens of 150 mm in diameter by 170 mm high, a single applied stress or deviator stress level of 276 kPa and 69 kPa confinement pressure at 40° C., with the deviator stress repeatedly pulsed in a vertical direction on the specimens using a haversine pulse load of 0.1 seconds and 0.9 seconds rest period until flow or 10,000 load cycles, equal to an identical asphalt SBS mix in terms of mix design, grading, aggregate type and binder content, based on an A-E2 conforming SBS binder, or at least 25% better than a performance of the identical asphalt SBS mix.

20. The method according to claim 18, wherein the asphalt mix is a medium continuously graded mix and has a flow number, using a UTM-25 test setup for dynamic modulus testing, with gyratory compacted specimens size of 100 mm diameter and 150 mm high cored from cylindrical medium continuous specimens of 150 mm in diameter by 170 mm high, a single applied stress or deviator stress level of 276 kPa and 69 kPa confinement pressure at 40° C., with the deviator stress repeatedly pulsed in a vertical direction on the specimens using a haversine pulse load of 0.1 seconds and 0.9 seconds rest period until flow or 10,000 load cycles, equal to an identical asphalt SBS mix in terms of mix design, grading, aggregate type and binder content based on an A-E2 conforming SBS binder, or at least 25% better, than a performance of the identical asphalt SBS mix.

21. The method according to claim 18, wherein the asphalt mix is a bitumen-rubber asphalt semi-open (BRASO) graded mix and has a maximum displacement, using a UTM-25 test setup for dynamic modulus testing, with gyratory compacted specimens size of 100 mm diameter and 150 mm high cored from cylindrical medium continuous specimens of 150 mm in diameter by 170 mm high, a single applied stress or deviator stress level of 276 kPa and 69 kPa confinement pressure at 40° C., with the deviator stress repeatedly pulsed in a vertical direction on the specimens using a haversine pulse load of 0.1 seconds and 0.9 seconds rest period until flow or 10,000 load cycles, equal to an identical asphalt mix in terms of mix design, grading, aggregate type and binder content, based on an A-R1 conforming crumb rubber modified bituminous binder, or at least 25% better than a performance of the identical asphalt mix based on an A-R1 conforming crumb rubber modified bituminous binder.

22. The method according to claim 18, wherein the asphalt mix is a bitumen-rubber asphalt semi-open (BRASO) graded mix and has a flow number, using a UTM-25 test setup for dynamic modulus testing, with gyratory compacted specimens size of 100 mm diameter and 150 mm high cored from cylindrical medium continuous specimens of 150 mm in diameter by 170 mm high, a single applied stress or deviator stress level of 276 kPa and 69 kPa confinement pressure at 40° C., with the deviator stress repeatedly pulsed in a vertical direction on the specimens using a haversine pulse load of 0.1 seconds and 0.9 seconds rest period until flow or 10,000 load cycles, equal to an identical asphalt mix in terms of mix design, grading, aggregate type and binder content, based on an A-R1 conforming crumb rubber modified bituminous binder, or at least 25% better than a performance of the identical asphalt mix based on an A-R1 conforming crumb rubber modified bituminous binder.
